(19) United States
(12) Patent Application Publication
(10) Pub. No.: US 2004/0251422 A1
(43) Pub. Date: Dec. 16, 2004

(54) Ionization chamber detector system for the detection and measurement of nuclear radiation including beta, gamma, and x-ray radiation

(76) Inventor: Mario W. Overhoff, Cincinnati, OH (US)

Correspondence Address: Patrick P. Phillips, Kremblas, Foster, Phillips & Pollick, 7632 Slate Ridge Blvd, Reynoldsburg, OH, 43068, US

(21) Appl. No.: 10/766,717

(22) Filed: Jan. 27, 2004

Related U.S. Application Data
(60) Provisional application No. 60/442,962, filed on Jan. 27, 2003.

(51) Int. Cl. G01T 1/18

(52) U.S. Cl. 250/376

(57) ABSTRACT

A nuclear detection and measurement system is provided having an ionization chamber with the ionization chamber having enclosed therein a balanced electrometer. The system includes a housing enclosing the ionization chamber, with the housing also enclosing circuitry, a battery, a power source, a microprocessor, and an analog section. The analog section is intermediate and connected by circuitry to the ionization chamber and the microprocessor. The housing has a display panel, and an on/off switch, with the circuitry connecting the power supply to the battery, the on/off switch, the microprocessor, and the display panel. The housing also includes a wireless link, a GPS unit, an RS232 port, a USB port, an alarm, and a battery charger. There is a handle secured to the housing, with the housing having on its exterior a plurality of connections for the RS232 port, the USB port, and the battery charger, and a point of attachment for a bar code reader. In another embodiment, the ionization chamber encloses a second ionization chamber, with the second ionization chamber having enclosed therein a second electrometer.

### CROSS-REFERENCE TO RELATED APPLICATION

This application claims the benefit of U.S. Provisional Application No. 60/442,962 filed Jan. 27, 2003.

### BACKGROUND OF THE INVENTION

1. Field Of The Invention

This invention is directed to a device used to detect and measure radiation, and one particularly to a sensitive, portable detector which can detect and measure beta, gamma, and x-ray radiation.

2. Description Of The Related Art

This invention is directed to a detector system for the detection and measurement of nuclear radiation. Devices used to detect and measure radiation are not new. In the health care field, they have been used in conjunction with radio-pharmaceuticals. They have also been used at nuclear power plants or other locations where it is desired to detect and measure any nuclear radiation that may be present.

In general, two types of prior art devices exist for detecting and measuring radiation. The first type of device uses either a scintillation multiplier tube detector (also referred to as a scintillator detector) or a Geiger-Müller tube. While this type of device is very sensitive, its significant drawback is that it cannot detect all the sources of radiation which are detectable by another type of prior art device known as an ion chamber.

The second type of prior art device is the aforementioned ion chamber. Conventional ion chambers that can detect beta, gamma, and x-ray radiation already have been developed. These instruments are known to use argon gas associated with pressures within the ion chamber of close to 10 atmospheres. However, these types of instruments have two drawbacks. First, because of their size, their use often has been confined to fixed locations. Secondly, and perhaps more importantly, they are not as sensitive as is desired or, put another way, as modern need requires. Examples of products made in accordance with both types of the prior art include those made by Thermo Eberline (formerly Thermo Electron and Eberline respectively), Victoreen, and Ludlum.

It is thus apparent that the need exists for a nuclear radiation detector system that can detect and measure nuclear radiation including beta, gamma, and x-ray radiation, and is as sensitive as modern need requires. Additionally, the need exists for such a system that is also extremely portable.

### SUMMARY OF THE INVENTION

In accordance with the present invention, a nuclear detection and measurement system is provided having an ionization chamber, with the chamber having a plurality of sidewalls, one of the sidewalls having a window, and with the ionization chamber having enclosed therein an electrometer. Preferably, the electrometer is a balanced electrometer.

The system also includes a housing, with the housing enclosing the ionization chamber. The housing also encloses circuitry, a battery, a power source, a microprocessor, and an analog section, with the analog section being intermediate and connected by circuitry to the ionization chamber and the microprocessor. The housing also has a display panel, and an on/off switch, with the circuitry connecting the power supply to the battery, the on/off switch, the microprocessor, and the display panel. The housing also includes a wireless link, a GPS unit, an RS232 port, a USB port, an alarm, and a battery charger.

The system includes a handle secured to the housing, with the housing having on its exterior a plurality of connections for the RS232 port, the USB port, and the battery charger, and a point of attachment for a bar code reader. The housing has on its exterior a display panel having digital and bar graph displays, with the display panel displaying both dose rate and dose. The ionization chamber can include a multi-range switch.

In a modified embodiment of the invention, the ionization chamber encloses a second ionization chamber, with the second ionization chamber having enclosed therein a second electrometer. In this modified embodiment of the invention, preferably the second electrometer is a balanced electrometer.

There is also disclosed a nuclear detection and measurement system having an ionization chamber with the ionization chamber having enclosed therein a balanced electrometer. The system includes a housing enclosing the ionization chamber, with the housing also enclosing circuitry, a battery, a power source, a microprocessor, and an analog section. The analog section is intermediate and connected by circuitry to the ionization chamber and the microprocessor.

The housing has a display panel, and an on/off switch, with the circuitry connecting the power supply to the battery, the on/off switch, the microprocessor, and the display panel. The housing also includes a wireless link, a GPS unit, an RS232 port, a USB port, an alarm, and a battery charger. There is a handle secured to the housing, with the housing having on its exterior a plurality of connections for the RS232 port, the USB port, and the battery charger, and a point of attachment for a bar code reader. The housing has on its exterior a display panel having digital and bar graph displays, with the display panel displaying both dose rate and dose. The ionization chamber can include a multi-range switch.

In a modified embodiment of the invention, the ionization chamber encloses a second ionization chamber, with the second ionization chamber having enclosed therein a second electrometer. In this system the second electrometer is a balanced electrometer.

The primary objective of this invention is to provide an ionization chamber detector system for the detection and measurement of beta, gamma, and x-ray radiation that has improved sensitivity.

Another objective of this invention is to provide a system that is portable.

Still another objective of this invention is to provide a system that compensates for temperature drifts.

Other objects and advantages of the invention will be apparent from the following description, the accompanying drawings and the appended claims.

### BRIEF DESCRIPTION OF THE DRAWINGS

FIG. 1 is a perspective view of a nuclear detection and measurement system made in accordance with the present invention.

FIG. 2 is a bottom plan view of the invention shown in FIG. 1.

FIG. 3 is a schematic of the present invention.

FIG. 4 is a partial schematic of a modified embodiment of the invention showing a schematic only of the ionization chamber.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

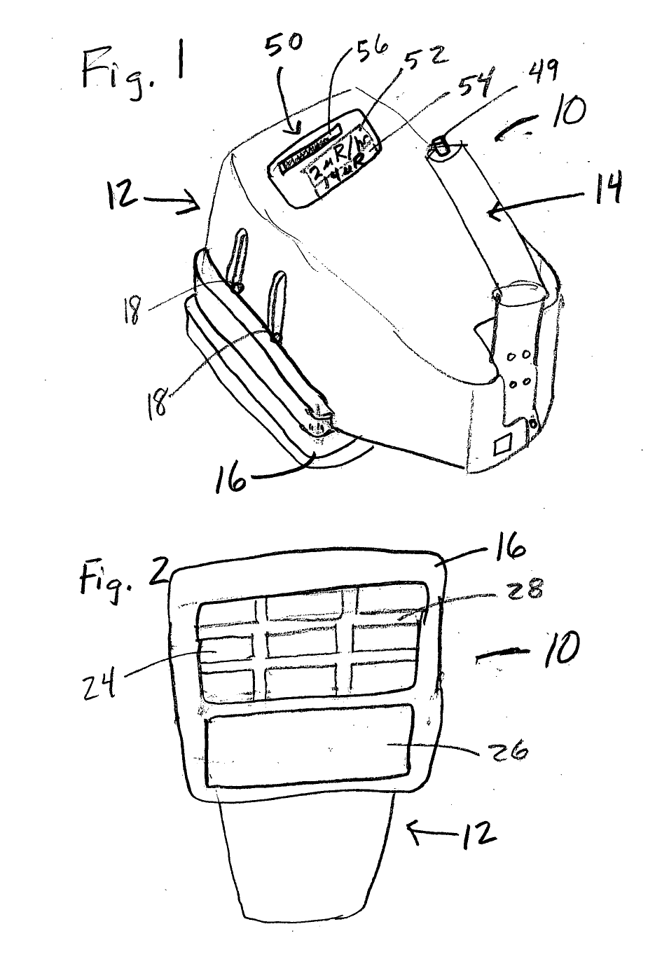

Having reference to the drawings, attention is directed first to FIG. 1, which discloses an ionization chamber detector system for the detection and measurement of nuclear radiation including beta, gamma and x-ray radiation made in accordance with the present invention and designated generally by the numeral 10. In its general form, the device is used chiefly as a battery powered hand held device, referred to as a “survey meter”, but it is also referred to by some as a gamma-beta radiation detector or an ionization chamber detector system.

As can be appreciated from FIG. 1, the system 10 has a housing 12 that could be fabricated from a molded plastic or a similar suitable material. This housing holds the ionization chamber assembly 20, the associated electronics and circuitry 80, and the battery/power source. The electrical and electronic circuitry 80 associated with the invention would be readily ascertainable to one of ordinary skill in the art. Attached to the housing 12 is a handle 14, with the handle 14 shown as being secured at one end of the housing 12. Attached to the bottom of the housing 12 by attachment means 18 such as screws is a metal frame member 16.

As can be appreciated from a comparison of FIGS. 1, 2, and 3, inside housing 12 is an ionization chamber 20. The ionization chamber 20 has a sidewall 22, preferably five planar ones that form an enclosed structure with a thin window 24 being present on the bottom of the ionization chamber. This thin window 24 is actually a metalized film of the type well known in the art of these devices. The thickness of the window is about 7 mg/cm². The thin window permits the measurement of the radiation. To prevent the window from bursting due to the increased pressure within the ionization chamber 20 a grid 28 is provided having a plurality of apertures formed therein to permit the passage therethrough of radioactive particles.

The ionization chamber 20 is preferably fabricated from steel and is pressurized to several atmospheres using a gas other than argon which is the gas used in the prior art. In this invention, the gas selected is preferably a dense gas, and in the preferred embodiment of this invention the gas is xenon. As a result sensitivity is maximized. The pressure can be as high as the thin metallized window will withstand, although in the preferred embodiment of the invention the pressure is at a level of 2 atmospheres, a level significantly less than the 10 atmosphere level associated with argon pressurized devices. The use of xenon or other high density gas with such devices is believed to be new, since the choice of gas in prior art devices has been argon. Additionally, while there are other high pressure ionization chamber systems commercially available, they are significantly larger and bulkier, such that they can not be considered to be hand-held.

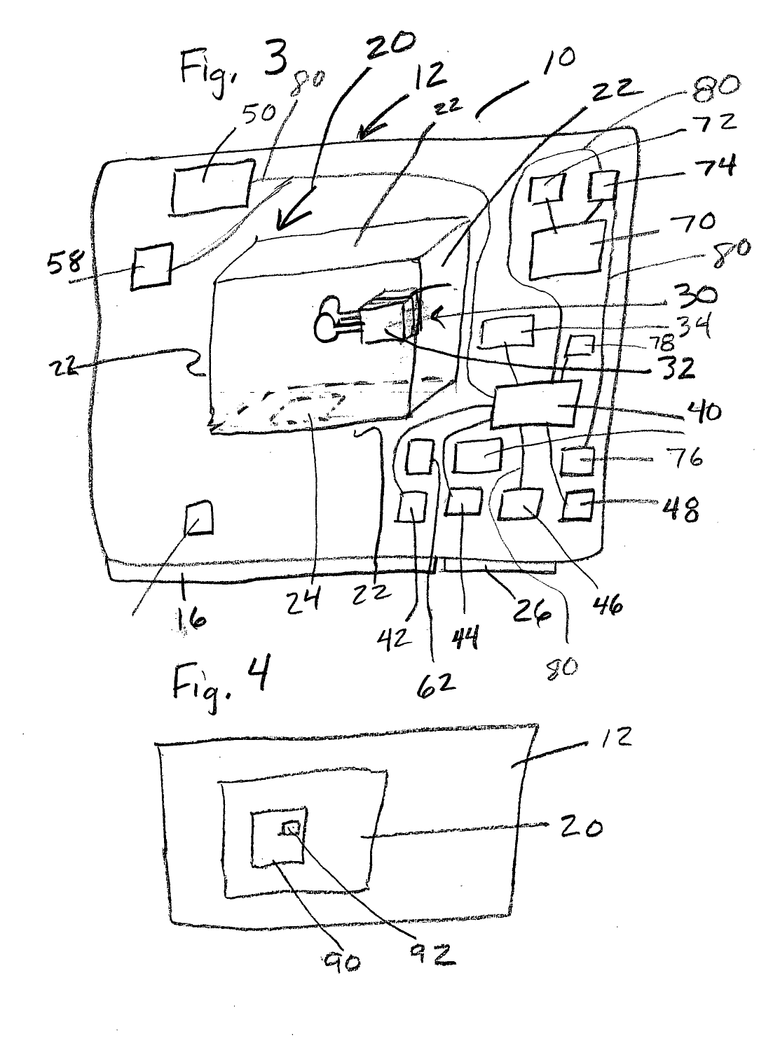

The ionization chamber 20 also is slidably equipped with a metal shield plate 26 as can best be appreciated from a comparison of FIGS. 2 and 3, with this plate being electrically insulated from the chamber 20 itself by means of the window 24.

The ionization chamber 20 is therefore, in essence, insulated from any electronic signal circuitry so that the instrument can be electrically connected to the outside by any suitable means. The front plate 26 slides over the window in the manner well known in the art when the device is not in use. With the window 24 uncovered, detection and measurement of beta radiation can be accomplished. With the window covered, detection and measurement of gamma and x-ray radiation can be accomplished.

Another distinguishing feature of the invention is that the system's electrometer 30 is located inside the ionization chamber as can be appreciated from FIG. 3. The electrometer is the electronic part which converts the ionization current inside the ionization chamber into a useable signal. In the prior art, the electrometer is located outside the ionization chamber.

Moreover, in prior art devices the electrometer experiences drift with changes in relative humidity. This drift lowers sensitivity to the radiation that the device is trying to detect and measure. The prior art has attempted to solve the problem by increasing the pressure in the ionization chamber to make the instrument more sensitive. It has been unexpectedly found in light of this long felt need that placing the electrometer inside the ionization chamber eliminates this problem.

Meanwhile, the electrometer 30 used here incorporates what is believed to be yet another new design feature. It uses a double electrometer amplifier system 32, with two identical operational amplifiers (or transistor units) where one is used to measure the ionization circuit, and the second unit is used to compensate for temperature induced offset voltage and offset current phenomena. The two amplifiers are simply balanced with a single trimmer potentiometer to produce an almost completely error free measurement from temperatures as low as −40° C. to temperatures as high as +50° C.

Consequently, the device of this invention is not affected by temperature shock. For example, the tracking of temperature provides a device in which the amplifiers balance each other to prevent temperature offset. While the double electrometer 32 (also known as a balanced electrometer) of this invention in its preferred embodiment uses a single chip, it should be recognized that the integrated circuits could be separated.

In accordance with this invention, the use of an internally mounted electrometer 30 using dual amplifiers results in an improvement of at least two orders of magnitude in sensitivity, stability and accuracy compared to conventional ionization chamber nuclear radiation detector systems for any given size of ionization chamber. Plus, the pressures need not be as high as in prior art devices.

In the present preferred embodiment of this invention, the analog signals from the balanced electrometer 32 is first combined and then digitized at an analog section 34 and then transmitted to a microprocessor 40. From there the information can proceed to a communicator link such as a RS-232 42, a USB 44, or to display 50.

Other optional features shown in FIG. 3 include a GPS receiver 46 and a bar code attachment 48 to permit a bar code reader (not shown, but of the type well known in the art) to be attached to the radiation detector, thereby facilitating the record keeping of what and where a reading is taken. Additionally, a button 49 located at the apex of the handle 14 shown in FIG. 1 permits the logging of specific measurements at a specific point in time to be recorded into memory for subsequent use.

The microprocessor 40 is programmed in a manner well known in the art to display a variety of useful information, such as by way of example, radiation dose rate 52 and radiation dose 54 either in digital or bar graph form 56. The display 50 may utilize an organic LED. An alarm 58, either audible or vibratory, is preferably provided to be activated if a preset radiation level is exceeded.

Furthermore, the microprocessor 40 of the invention can be connected to an internal wireless transmitter or wireless link 62 so that the data can be transmitted elsewhere. The microprocessor 40 with its memory can also be programmed to record and store (i.e., archive) historical data, including dose and rate on a continuous basis for later transfer to a computer for recordkeeping purposes, for analysis, or for safety reasons.

In its portable form, the instrument 10 of this invention is preferably powered by a battery 70 which is preferably rechargeable. A battery charger 72 is connected to the battery, and the battery is connected to the power supply 74. A multi-range switch 78 triggered by the microprocessor can replace yet a third instrument by permitting the detection and measurement of the ultra-high range only of radiation.

Finally, a modified embodiment of the invention can be appreciated as being partially shown in FIG. 4. This modification concerns the ionization chamber 20, which can be appreciated in the modification as having a second ionization chamber 90 contained therein. Enclosed in this second ionization chamber 90 is a second electrometer, which in the preferred embodiment of the modified embodiment of the invention is a balanced electrometer.

In actual use, the device of this invention can be used outdoors, free of temperature and humidity effects. That is because the device of this invention does not experience temperature drift, pressure drift or humidity drift. It enables even normal background radiation to be detected and measured in a hand-held instrument. The features associated with this invention permit this single device to effectively replace three types of detection devices currently in use, plus also result in a substantial increase in sensitivity over previous designs of ion chamber devices. The sensitivity and dynamic range of the device of this invention is from 1 μR/h to 10⁷ μR/h in the preferred embodiment associated with FIG. 3, and to 10⁹ μR/h in the modified embodiment of the invention associated with FIG. 4. Thus the invention performs at a level heretofore unknown, while at the same time experiencing none of the major drawbacks associated with prior art devices.

While the form of apparatus herein described constitutes a preferred embodiment of the present invention, it is to be understood that the invention is not limited to this precise form of apparatus and that changes may be made therein without departing from the scope of the invention which is defined in the appended claims.

What is claimed is:

1. A nuclear detection and measurement system comprising an ionization chamber, said chamber having a plurality of sidewalls, one of said sidewalls having a window, said ionization chamber having enclosed therein an electrometer, said electrometer being a balanced electrometer.

2. The system according to claim 1 which includes a housing, said housing enclosing said ionization chamber, said housing also enclosing circuitry, a battery, a power source, a microprocessor, and an analog section, said analog section being intermediate and connected by circuitry to said ionization chamber and said microprocessor, said housing also having a display panel, and an on/off switch, said circuitry connecting said power supply to said battery, said on/off switch, said microprocessor, and said display panel.

3. The system according to claim 2 wherein said housing also includes a wireless link, a GPS unit, an RS232 port, a USB port, an alarm, and a battery charger.

4. The system according to claim 2 which includes a handle secured to said housing, said housing having on its exterior a plurality of connections for said RS232 port, said USB port, and said battery charger, and a point of attachment for a bar code reader.

5. The system according to claim 1 wherein said ionization chamber is enclosed in a housing, said housing having on its exterior a display panel having digital and bar graph displays, said display panel displaying both dose rate and dose.

6. The system according to claim 1 wherein said ionization chamber includes a multi-range switch.

7. The system according to claim 1 wherein said ionization chamber encloses a second ionization chamber, said second ionization chamber having enclosed therein a second electrometer.

8. The system according to claim 7 wherein second electrometer is a balanced electrometer.

9. A nuclear detection and measurement system comprising an ionization chamber, said ionization chamber having enclosed therein a balanced electrometer.

10. The system according to claim 9 which includes a housing, said housing enclosing said ionization chamber, said housing also enclosing circuitry, a battery, a power source, a microprocessor, and an analog section, said analog section being intermediate and connected by circuitry to said ionization chamber and said microprocessor, said housing also having a display panel, and an on/off switch, said circuitry connecting said power supply to said battery, said on/off switch, said microprocessor, and said display panel.

11. The system according to claim 10 wherein said housing also includes a wireless link, a GPS unit, an RS232 port, a USB port, an alarm, and a battery charger.

12. The system according to claim 11 which includes a handle secured to said housing, said housing having on its exterior a plurality of connections for said RS232 port, said USB port, and said battery charger, and a point of attachment for a bar code reader.

13. The system according to claim 9 wherein said ionization chamber is enclosed in a housing, said housing having on its exterior a display panel having digital and bar graph displays, said display panel displaying both dose rate and dose.

14. The system according to claim 9 wherein said ionization chamber includes a multi-range switch.

15. The system according to claim 9 wherein said ionization chamber encloses a second ionization chamber, said second ionization chamber having enclosed therein a second electrometer.

16. The system according to claim 15 wherein said second electrometer is a balanced electrometer.
